(19) United States
(12) Patent Application Publication
(10) Pub. No.: US 2022/0358907 A1
(43) Pub. Date: Nov. 10, 2022

(54) METHOD FOR PROVIDING RESPONSE OF VOICE INPUT AND ELECTRONIC DEVICE SUPPORTING THE SAME

(71) Applicant: Samsung Electronics Co., Ltd., Suwon-si (KR)

(72) Inventors: Jooyong BYEON, Suwon-si (KR); Kichul KIM, Suwon-si (KR); Jongwon LEE, Suwon-si (KR)

(21) Appl. No.: 17/874,972

(22) Filed: Jul. 27, 2022

Related U.S. Application Data
(63) Continuation of application No. PCT/KR2021/019149, filed on Dec. 16, 2021.

(30) Foreign Application Priority Data
Dec. 16, 2020 (KR) 10-2020-0176703

(51) Int. Cl. G10L 15/02; G06F 3/16

(52) U.S. Cl. CPC G10L 15/02; G06F 3/16

(57) ABSTRACT

There is provided an electronic device including: a microphone, an output device comprising output circuitry, and a processor operatively connected with the microphone and the output device, wherein the processor is configured to: analyze a voice input acquired through the microphone; based on a result of analyzing the voice input, determine whether to provide a response by retrieving information included in the result of analyzing the voice input; based on a determination to provide the response by retrieving the information, acquire data by retrieving the information; based on preference information, extract feature information from the acquired data; generate the response to include at least one piece of information of the extracted feature information; and control the output device to output the generated response.

### CROSS-REFERENCE TO RELATED APPLICATIONS

This application is a continuation of International Application No. PCT/KR2021/019149 designating the United States, filed on Dec. 16, 2021, in the Korean Intellectual Property Receiving Office and claiming priority to Korean Patent Application No. 10-2020-0176703, filed on Dec. 16, 2020, in the Korean Intellectual Property Office, the disclosures of which are incorporated by reference herein in their entireties.

### BACKGROUND

### Field

The disclosure relates to a method for providing a response to a voice input and an electronic device supporting the same.

### Description of Related Art

An artificial intelligence (AI) system (or an integrated intelligence system) may be a computer system that implements intelligence in the level of a human, and may be a system that enables a machine to learn and determine by itself and enhances a recognition rate as the system is used more and more.

AI technology may include machine learning (deep learning) technology which uses an algorithm for classifying and/or learning features of input data by itself, and element technology which replicates functions of the human brain, such as recognizing, determining, by utilizing a machine learning algorithm.

The element technologies may include at least one of linguistic understanding technology for recognizing human language and/or text, visual understanding technology for recognizing things like human vision, inference and/or prediction technology for logically inferring and predicting by determining information, knowledge representation technology for processing experience information of humans to knowledge data, and operation control technology for controlling auto driving of vehicles, robots' motions.

The linguistic understanding technology of the above-described element technologies may refer, for example, to technology for recognizing human language and/or text and applying/processing, and may include natural language processing, machine translation, a dialogue system, question and response, voice recognition and/or synthesis. For example, an electronic device having an AI system mounted therein may provide a response to a voice input which is received through a microphone.

When generating a response to a received voice input, a related-art electronic device may generate the response by using a pre-defined template which matches an (utterance) intention of a user and an element necessary for generating a response (for example, a parameter (referred to as a slot, a tag, or metadata)). Herein, the template may refer to a format of a response that is provided according to a user's intention and is pre-stored in the form of an incomplete sentence, and a sentence in the template may be completed by filling (or substituting) the element portion included in the template. For example, when generating a response providing information, the related-art electronic device may generate the response with a sentence which is completed by substituting the element portion in the template, which is pre-defined according to a user's intention, with a result of retrieving information.

However, when the template is used for generating a response providing information, it may be difficult to provide a response including information preferred by the user, for example, a user-customized response.

### SUMMARY

Embodiments of the disclosure may provide a method for providing a response based on user preference and an electronic device supporting the same.

An electronic device according to various example embodiments of the disclosure may include: a microphone, an output device including output circuitry, and a processor operatively connected with the microphone and the output device, and the processor may be configured to: analyze a voice input acquired through the microphone, based on a result of analyzing the voice input, determine whether to provide a response by retrieving information included in the result of analyzing the voice input, based on a determination to provide the response by retrieving the information, acquire data by retrieving the information, based on preference information, extract feature information from the acquired data, generate the response to include at least one piece of information of the extracted feature information, and control the output device to output the generated response.

In addition, an electronic device according to various example embodiments of the disclosure may include: a communication circuit and a processor operatively connected with the communication circuit, and the processor may be configured to: acquire a voice input from an external electronic device connected through the communication circuit, analyze the acquired voice input, determine whether to provide a response by retrieving information included in a result of analyzing the acquired voice input, based on the result of analyzing the acquired voice input, based on a determination to provide the response by retrieving the information, acquire data by retrieving the information, extract feature information from the acquired data, based on preference information, generate the response to include at least one piece of information in the extracted feature information, and control the communication circuit to transmit the generated response to the external electronic device.

In addition, a method for providing a response to a voice input according to various example embodiments of the disclosure may include: acquiring and analyzing a voice input, based on a result of analyzing the voice input, determining whether to provide a response by retrieving information included in the result of analyzing the voice input, based on a determination to provide the response by retrieving the information, acquiring data by retrieving the information, based on preference information, extracting feature information from the acquired data, generating the response to include at least one piece of information of the extracted feature information, and outputting the generated response.

According to various example embodiments, in generating a response for providing information, importance of information is determined based on user's preference, and the response is generated by using important information, so that a user-customized response can be provided, and accordingly, availability of the electronic device can be enhanced.

In addition, there are various effects that can be directly or indirectly understood through the disclosure.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an integrated intelligence system according to various embodiments;

FIG. 2 is a diagram illustrating relationship information between a concept and an operation which is stored in a database according to various embodiments;

FIG. 3 is a diagram illustrating a user terminal displaying a screen which processes a voice input received through an intelligent application according to various embodiments;

FIG. 4 is a block diagram illustrating an example configuration of an electronic device according to various embodiments;

FIG. 5 is a diagram illustrating an example configuration of an electronic device related to providing of a response to a voice input according various embodiments;

FIG. 6 is a flowchart illustrating an example method for providing a response to a voice input according to various embodiments;

FIG. 7 is a flowchart illustrating an example method for providing a response to a voice input according to various embodiments;

FIG. 8 is a flowchart illustrating an example method for generating and correcting a response based on user's preference according to various embodiments;

FIG. 9 is a diagram illustrating an example method for generating a response based on user's preference using structured retrieval data according to various embodiments;

FIG. 10 is a diagram illustrating an example method for generating a response based on user's preference using structured retrieval data according to various embodiments;

FIG. 11 is a diagram illustrating an example method for generating a response based on user's preference using unstructured retrieval data according to various embodiments;

FIG. 12 is a diagram illustrating an example method for generating a response based on user's preference using unstructured retrieval data according to various embodiments;

FIG. 13 is a diagram illustrating an example method for generating a response based on a weight given to retrieval data according to various embodiments;

FIG. 14 is a diagram illustrating an example method for generating a response based on a weight given to retrieval data according to various embodiments; and

FIG. 15 is a block diagram illustrating an example electronic device in a network environment according to various embodiments.

With regard to the description of the drawings, the same or similar reference numerals may be used to refer to the same or similar elements.

### DETAILED DESCRIPTION

Hereinafter, various example embodiments of the disclosure will be described with reference to the accompanying drawings. For convenience of explanation, dimensions of elements illustrated in the drawings may be exaggerated or reduced, and various embodiments of the disclosure are not limited to those illustrated.

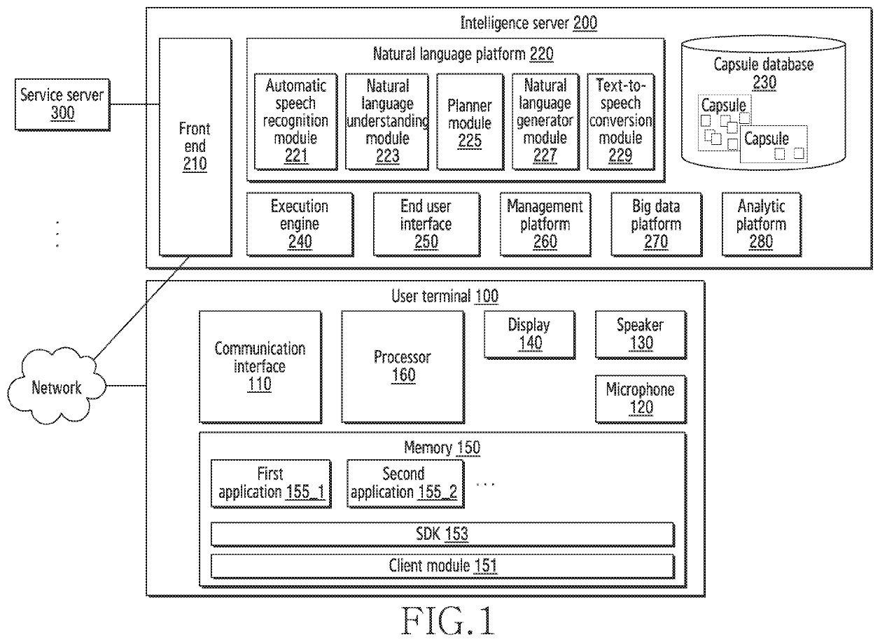

FIG. 1 is a block diagram illustrating an example configuration of an integrated intelligence system according to various embodiments.

Referring to FIG. 1, the integrated intelligence system of an embodiment may include a user terminal 100, an intelligence server 200, and a service server 300.

The user terminal 100 of an embodiment may be a terminal device (or an electronic device) possible to be coupled to the Internet and, for example, may be a portable phone, a smart phone, a personal digital assistant (PDA), a notebook computer, a television (TV), a home appliance, a wearable device, a head mounted device (HMD), a smart speaker, or the like.

According to an embodiment illustrated, the user terminal 100 may include a communication interface (e.g., including communication circuitry) 110, a microphone 120, a speaker 130, a display 140, a memory 150, and/or a processor (e.g., including processing circuitry) 160. The enumerated elements may be operatively or electrically coupled with each other.

The communication interface 110 of an embodiment may include various communication circuitry and be configured to be coupled with an external device and transmit and/or receive data with the external device. The microphone 120 of an embodiment may receive a sound (e.g., a user utterance) and convert the sound into an electrical signal. The speaker 130 of an embodiment may output an electrical signal as a sound (e.g., a voice). The display 140 of an embodiment may be configured to display an image or video. The display 140 of an embodiment may also display a graphic user interface (GUI) of an executed app (or application program).

The memory 150 of an embodiment may store a client module 151, a software development kit (SDK) 153, and a plurality of applications (apps) 155. The client module 151 and the SDK 153 may configure a framework (or solution program) for performing a generic function. Also, the client module 151 or the SDK 153 may configure a framework for processing a voice input.

The plurality of apps 155 stored in the memory 150 of an embodiment may be a program for performing a designated function. According to an embodiment, the plurality of apps 155 may include a first application (app) 155_1 and a second application (app) 155_2. According to an embodiment, the plurality of apps 155 may each include a plurality of actions for performing a designated function. For example, the apps may include an alarm app, a message app, and/or a schedule app. According to an embodiment, the plurality of apps 155 may be executed by the processor 160, and execute at least some of the plurality of actions in sequence.

The processor 160 of an embodiment may include various processing circuitry and control a general operation of the user terminal 100. For example, the processor 160 may be electrically coupled with the communication interface 110, the microphone 120, the speaker 130, and the display 140, and perform a designated operation.

The processor 160 of an embodiment may also execute a program stored in the memory 150, and perform a designated function. For example, the processor 160 may execute at least one of the client module 151 or the SDK 153, and perform a subsequent operation for processing a voice input. The processor 160 may, for example, control operations of the plurality of apps 155 through the SDK 153. An operation of the client module 151 or the SDK 153 explained in the following may be an operation by the execution of the processor 160.

The client module 151 of an embodiment may receive a voice input. For example, the client module 151 may receive a voice signal corresponding to a user utterance which is sensed through the microphone 120. The client module 151 may transmit the received voice input to the intelligence server 200. The client module 151 may transmit state information of the user terminal 100 to the intelligence server 200, together with the received voice input. The state information may be, for example, app execution state information.

The client module 151 of an embodiment may receive a result corresponding to the received voice input. For example, in response to the intelligence server 200 being capable of calculating the result corresponding to the received voice input, the client module 151 may receive the result corresponding to the received voice input from the intelligence server 200. The client module 151 may display the received result on the display 140.

The client module 151 of an embodiment may receive a plan corresponding to the received voice input. The client module 151 may display, on the display 140, a result of executing a plurality of actions of an app according to the plan. The client module 151 may, for example, display the result of execution of the plurality of actions in sequence on the display. The user terminal 100 may, for another example, display only a partial result (e.g., a result of the last operation) of executing the plurality of actions on the display.

According to an embodiment, the client module 151 may receive a request for obtaining information necessary for calculating a result corresponding to a voice input, from the intelligence server 200. According to an embodiment, in response to the request, the client module 151 may transmit the necessary information to the intelligence server 200.

The client module 151 of an embodiment may transmit result information of executing a plurality of actions according to a plan, to the intelligence server 200. Using the result information, the intelligence server 200 may identify that the received voice input is processed rightly.

The client module 151 of an embodiment may include a voice recognition module. According to an embodiment, the client module 151 may recognize a voice input of performing a restricted function through the voice recognition module. For example, the client module 151 may perform an intelligence app for processing a voice input for performing a systematic operation through a designated input (e.g., wake up!)

The intelligence server 200 of an embodiment may receive information related with a user voice input from the user terminal 100 through a communication network. According to an embodiment, the intelligence server 200 may convert data related with the received voice input into text data. According to an embodiment, the intelligence server 200 may generate a plan for performing a task corresponding to the user voice input on the basis of the text data.

According to an embodiment, the plan may be generated by an artificial intelligent (AI) system. The artificial intelligent system may include a rule-based system as well, and may be a neural network-based system (e.g., feedforward neural network (FNN)) and/or a recurrent neural network (RNN)) as well. The artificial intelligent system may be either a combination of the aforementioned or an artificial intelligent system different from this as well. According to an embodiment, the plan may be selected in a set of predefined plans, or may be generated in real time in response to a user request. For example, the artificial intelligent system may select at least one plan among a predefined plurality of plans.

The intelligence server 200 of an embodiment may transmit a result of the generated plan to the user terminal 100, or transmit the generated plan to the user terminal 100. According to an embodiment, the user terminal 100 may display the result of the plan on the display 140. According to an embodiment, the user terminal 100 may display a result of executing an action of the plan on the display 140.

The intelligence server 200 of an embodiment may include a front end (e.g., including circuitry) 210, a natural language platform (e.g., including various processing circuitry and/or executable program instructions) 220, a capsule database (DB) 230, an execution engine (e.g., including various processing circuitry and/or executable program instructions) 240, an end user interface (e.g., including interface circuitry) 250, a management platform (e.g., including various processing circuitry and/or executable program instructions) 260, a big data platform (e.g., including various processing circuitry and/or executable program instructions) 270, and/or an analytic platform (e.g., including various processing circuitry and/or executable program instructions) 280.

The front end 210 of an embodiment may include various circuitry and receive a voice input received from the user terminal 100. The front end 210 may transmit a response corresponding to the voice input.

According to an embodiment, the natural language platform 220 may include various modules, each including various processing circuitry and/or executable program instructions, including an automatic speech recognition module (ASR module) 221, a natural language understanding module (NLU module) 223, a planner module 225, a natural language generator module (NLG module) 227 and/or a text-to-speech conversion module (TTS module) 229.

The automatic speech recognition module 221 of an embodiment may convert a voice input received from the user terminal 100 into text data. Using the text data of the voice input, the natural language understanding module 223 of an embodiment may grasp a user's intention. For example, by performing syntactic analysis or semantic analysis, the natural language understanding module 223 may grasp the user's intention. Using a linguistic feature (e.g., syntactic factor) of a morpheme or phrase, the natural language understanding module 223 of an embodiment may grasp a meaning of a word extracted from the voice input, and match the grasped meaning of the word with the user intention, to identify the user's intention.

Using an intention and parameter identified by the natural language understanding module 223, the planner module 225 of an embodiment may generate a plan. According to an embodiment, on the basis of the identified intention, the planner module 225 may identify a plurality of domains necessary for performing a task. The planner module 225 may identify a plurality of actions included in each of the plurality of domains which are identified on the basis of the intention. According to an embodiment, the planner module 225 may identify a parameter necessary for executing the identified plurality of actions, or a result value output by the execution of the plurality of actions. The parameter and the result value may be defined with a concept of a designated form (or class). Accordingly to this, the plan may include the plurality of actions identified by the user's intention, and a plurality of concepts. The planner module 225 may identify a relationship between the plurality of actions and the plurality of concepts stepwise (or hierarchically). For example, on the basis of the plurality of concepts, the planner module 225 may identify a sequence of execution of the plurality of actions that are identified on the basis of the user intention. In other words, the planner module 225 may identify the sequence of execution of the plurality of actions, on the basis of the parameter necessary for execution of the plurality of actions and the result output by execution of the plurality of actions. Accordingly to this, the planner module 225 may generate a plan including association information (e.g., ontology) between the plurality of actions and the plurality of concepts. The planner module 225 may generate the plan using information stored in a capsule database 230 in which a set of relationships between the concept and the action is stored.

The natural language generator module 227 of an embodiment may convert designated information into a text form. The information converted into the text form may be a form of a natural language speech. The text-to-speech conversion module 229 of an embodiment may convert the information of the text form into information of a voice form.

According to an embodiment, a partial function or whole function of a function of the natural language platform 220 may be implemented even in the user terminal 100.

The capsule database 230 may store information about a relationship between a plurality of concepts and actions corresponding to a plurality of domains. A capsule of an embodiment may include a plurality of action objects (or action information) and concept objects (or concept information) which are included in a plan. According to an embodiment, the capsule database 230 may store a plurality of capsules in a form of a concept action network (CAN). According to an embodiment, the plurality of capsules may be stored in a function registry included in the capsule database 230.

The capsule database 230 may include a strategy registry storing strategy information which is necessary for identifying a plan corresponding to a voice input. The strategy information may include reference information for, in response to there being a plurality of plans corresponding to a voice input, identifying one plan. According to an embodiment, the capsule database 230 may include a follow up registry storing follow-up operation information for proposing a follow-up operation to a user in a designated condition. The follow-up operation may include, for example, a follow-up utterance. According to an embodiment, the capsule database 230 may include a layout registry storing layout information of information output through the user terminal 100. According to an embodiment, the capsule database 230 may include a vocabulary registry storing vocabulary information included in capsule information. According to an embodiment, the capsule database 230 may include a dialog registry storing user's dialog (or interaction) information. The capsule database 230 may update an object stored through a developer tool. The developer tool may include, for example, a function editor for updating an action object or a concept object. The developer tool may include a vocabulary editor for updating a vocabulary. The developer tool may include a strategy editor generating and registering a strategy of identifying a plan. The developer tool may include a dialog editor generating a dialog with a user. The developer tool may include a follow up editor which may edit a follow up speech activating a follow up target and providing a hint. The follow up target may be identified on the basis of a currently set target, a user's preference or an environment condition. In an embodiment, the capsule database 230 may be implemented even in the user terminal 100.

The execution engine 240 of an embodiment may calculate a result using the generated plan. The end user interface 250 may transmit the calculated result to the user terminal 100. Accordingly to this, the user terminal 100 may receive the result, and provide the received result to a user. The management platform 260 of an embodiment may manage information used in the intelligence server 200. The big data platform 270 of an embodiment may collect user's data. The analysis platform 280 of an embodiment may manage a quality of service (QoS) of the intelligence server 200. For example, the analysis platform 280 may manage a element and processing speed (or efficiency) of the intelligence server 200.

The service server 300 of an embodiment may provide a designated service (e.g., food order or hotel reservation) to the user terminal 100. According to an embodiment, the service server 300 may be a server managed by a third party. The service server 300 of an embodiment may provide information for generating a plan corresponding to a received voice input, to the intelligence server 200. The provided information may be stored in the capsule database 230. Also, the service server 300 may provide result information of the plan to the intelligence server 200.

In the above-described integrated intelligence system, in response to a user input, the user terminal 100 may provide various intelligent services to the user. The user input may include, for example, an input through a physical button, a touch input or a voice input.

In an embodiment, the user terminal 100 may provide a voice recognition service through an intelligence app (or a voice recognition app) stored therein. In this case, for example, the user terminal 100 may recognize a user utterance or voice input received through the microphone, and provide a service corresponding to the recognized voice input, to the user.

In an embodiment, the user terminal 100 may perform a designated operation, singly, or together with the intelligence server and/or the service server, on the basis of a received voice input. For example, the user terminal 100 may execute an app corresponding to the received voice input, and perform a designated operation through the executed app.

In an embodiment, in response to the user terminal 100 providing a service together with the intelligence server 200 and/or the service server, the user terminal 100 may sense a user utterance using the microphone 120, and generate a signal (or voice data) corresponding to the sensed user utterance. The user terminal 100 may transmit the voice data to the intelligence server 200 using the communication interface 110.

As a response to a voice input received from the user terminal 100, the intelligence server 200 of an embodiment may generate a plan for performing a task corresponding to the voice input, or a result of performing an action according to the plan. The plan may include, for example, a plurality of actions for performing a task corresponding to a user's voice input, and a plurality of concepts related with the plurality of actions. The concept may be a definition of a parameter input by execution of the plurality of actions or a result value output by the execution of the plurality of actions. The plan may include association information between the plurality of actions and the plurality of concepts.

The user terminal 100 of an embodiment may receive the response using the communication interface 110. The user terminal 100 may output a voice signal generated by the user terminal 100 to the external using the speaker 130, or output an image generated by the user terminal 100 to the external using the display 140.

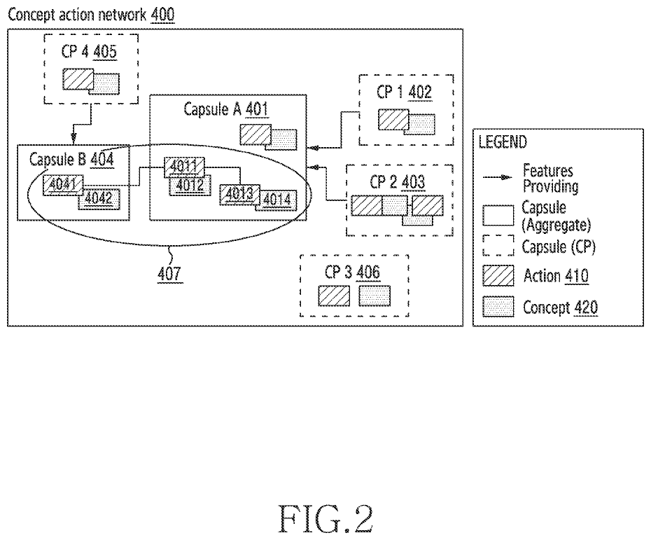

FIG. 2 is a diagram illustrating example relationship information between a concept and an action is stored in a database, according to various embodiments.

Referring to FIG. 2, a capsule database (e.g., the capsule database 230) of the intelligence server 200 may store a capsule in the form of a concept action network (CAN) 400. The capsule database may store an action for processing a task corresponding to a user's voice input and a parameter necessary for the action, in the form of the concept action network (CAN) 400.

The capsule database may store a plurality of capsules (e.g., a capsule A 401 and a capsule B 404) corresponding to each of a plurality of domains (e.g., applications). According to an embodiment, one capsule (e.g., the capsule A 401) may correspond to one domain (e.g., a location (geo) and/or an application). Also, one capsule may correspond to at least one service provider (e.g., a CP 1 402, a CP 2 403, a CP 3 406 or a CP 4 405) for performing a function of a domain related with the capsule. According to an embodiment, one capsule may include at least one or more actions 410 and at least one or more concepts 420, for performing a designated function.

Using a capsule stored in the capsule database, the natural language platform 220 may generate a plan for performing a task corresponding to a received voice input. For example, using the capsule stored in the capsule database, the planner module 225 of the natural language platform 220 may generate the plan. For example, the planner module 225 may generate a plan 407 using actions 4011 and 4013 and concepts 4012 and 4014 of the capsule A 401 and an action 4041 and concept 4042 of the capsule B 404.

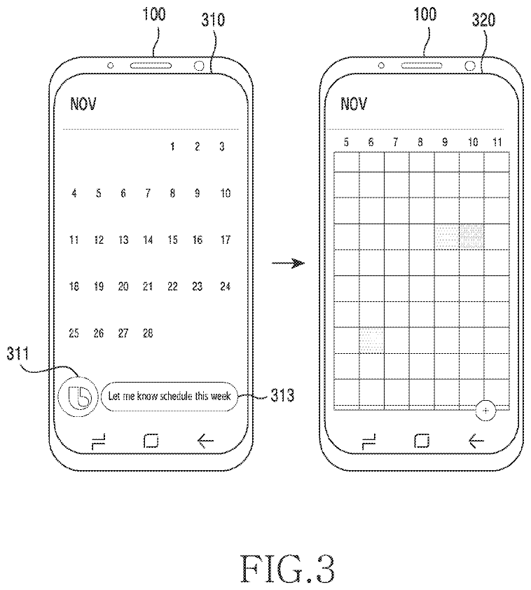

FIG. 3 is a diagram illustrating a screen in which a user terminal processes a received voice input through an intelligence app according to various embodiments.

To process a user input through the intelligence server 200, the user terminal 100 may execute the intelligence app.

According to an embodiment, in screen 310, in response to recognizing a designated voice input (e.g., wake up!) or receiving an input through a hardware key (e.g., a dedicated hardware key), the user terminal 100 may execute the intelligence app for processing the voice input. The user terminal 100 may, for example, execute the intelligence app in a state of executing a schedule app. According to an embodiment, the user terminal 100 may display an object (e.g., an icon) 311 corresponding to the intelligence app on the display 140. According to an embodiment, the user terminal 100 may receive a user input by a user speech. For example, the user terminal 100 may receive a voice input “Let me know a schedule this week!”. According to an embodiment, the user terminal 100 may display a user interface (UI) 313 (e.g., an input window) of the intelligence app in which text data of the received voice input is displayed, on the display.

According to an embodiment, in screen 320, the user terminal 100 may display a result corresponding to the received voice input on the display. For example, the user terminal 100 may receive a plan corresponding to the received user input, and display, on the display, ‘a schedule this week’ according to the plan.

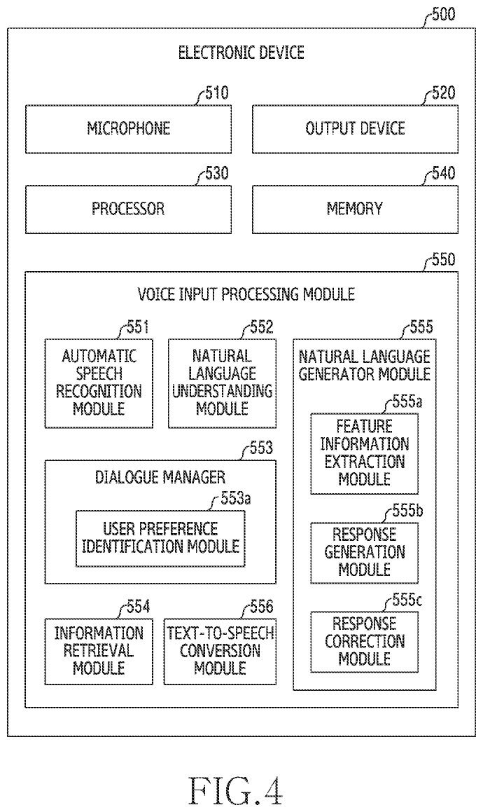

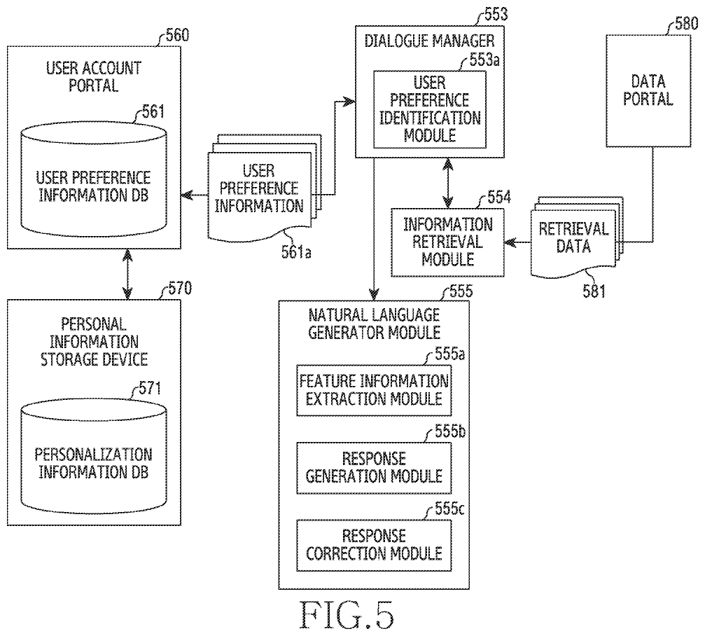

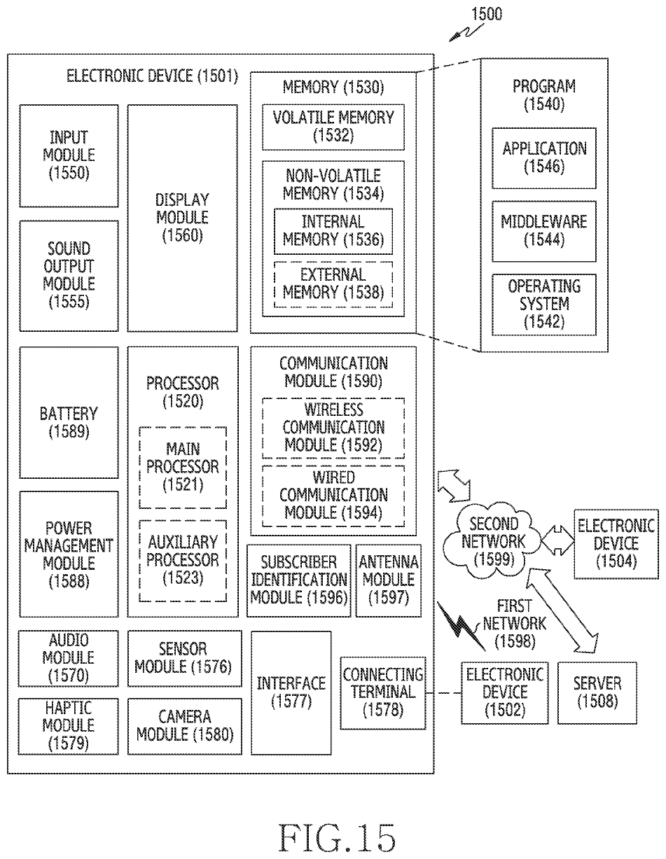

FIG. 4 is a block diagram illustrating an example configuration of an electronic device according to various embodiments, and FIG. 5 is a diagram illustrating an example configuration of an electronic device related to providing of a response to a voice input according to various embodiments. The electronic device 500 disclosed in FIG. 4 may be a device that performs similar functions to those of the user terminal 100 or the intelligence server 200 disclosed in FIG. 1. The electronic device 500 disclosed in FIG. 4 may be a device that complexly performs functions of the user terminal 100 disclosed in FIG. 1 and functions of the intelligence server 200. The electronic device 500 disclosed in FIG. 4 may be a device that has a similar configuration to that of an electronic device 1501 disclosed in FIG. 15.

Referring to FIGS. 4 and 5, the electronic device 500 may include a microphone 510 (for example, the microphone 120 of FIG. 1 or an input module 1550 of FIG. 15), an output device 520 (for example, the speaker 130 of FIG. 1, the display 140 of FIG. 1, a sound output device 1555 of FIG. 15, or a display module 1560 of FIG. 15), a processor (e.g., including processing circuitry) 530 (for example, the processor 160 of FIG. 1 or a processor 1520 of FIG. 15), a memory 540 (for example, the memory 150 of FIG. 1 or a memory 1530 of FIG. 15), and a voice input processing module (e.g., including various processing circuitry and/or executable program instructions) 550 (for example, the natural language platform 220 of FIG. 1 or the processor 1520 of FIG. 15). However, the configuration of the electronic device 500 is not limited thereto. According to an embodiment, when the electronic device 500 may be a device that performs similar functions to those of the user terminal 100 disclosed in FIG. 1, the electronic device 500 may omit the voice input processing module 550. According to an embodiment, when the electronic device 500 is a device that performs similar functions to those of the intelligence server 200 disclosed in FIG. 1, the electronic device 500 may omit the microphone 510 and the output device 520 and may further include a communication circuit (for example, the communication interface 110 of FIG. 1 or a communication module 1590 of FIG. 15).

The microphone 510 may receive a sound coming from the outside, for example, a voice signal (a voice input) caused by utterance of a user. In addition, the microphone 510 may convert the received voice signal into an electric signal, and may transmit the electric signal to the voice input processing module 550.

The output device 520 may include various output circuitry and output data which is processed in at least one component (for example, the processor 530 or the voice input processing module 550) of the electronic device 500 to the outside. The output device 520 may include, for example, a speaker or a display. According to an embodiment, the output device 520 may output voice data which is processed in the voice input processing module 550 through the speaker. According to an embodiment, the output device 520 may output visual data which is processed in the voice input processing module 550 through the display.

The processor 530 may include various processing circuitry and control at least one component of the electronic device 500, and may perform various data processing or computations. According to an embodiment, the processor 530 may control the voice input processing module 550 to perform a function related to processing of a voice input. According to an embodiment, the processor 530 may perform a function that is performed by the voice input processing module 550 by itself. In the following descriptions, it is illustrated that the voice input processing module 550 performs the function related to processing of the voice input, but this should not be considered as limiting. The processor 530 may perform at least one function that can be performed by the voice input processing module 550. For example, at least some component of the voice input processing module 550 may be included in the processor 530.

The memory 540 may store various data that is used by at least one component of the electronic device 500. According to an embodiment, the memory 540 may store an application that may perform at least one function. According to an embodiment, the memory 540 may store an instruction and data which are related to processing of a voice input. In this case, the instruction may be executed by the processor 530 or may be executed by the voice input processing module 550 under control of the processor 530. According to still an embodiment, the memory 540 may store information regarding types of responses which are matched with intentions of a user. According to an embodiment, the information regarding the types of responses matched with the intentions of the user may be stored in the memory 540 in the form of a table.

The voice input processing module 550 may process a user's voice input which is acquired through the microphone 510. To achieve this, the voice input processing module 550 may include various modules, each including various processing circuitry and/or executable program instructions, including, for example, an automatic speech recognition module 551, a natural language understanding module 552, a dialogue manager (DM) 553, an information retrieval module 554, a natural language generator module 555, and/or a text-to-speech conversion module 556.

The automatic speech recognition module 551 may perform a similar function to that of the automatic speech recognition module 221 of FIG. 1. The automatic speech recognition module 551 may convert a user's voice input which is acquired through the microphone 510 into text data. For example, the automatic speech recognition module 551 may include an utterance recognition module. The utterance recognition module may include an acoustic model and a language model. The acoustic model may include information regarding vocalization, and the language model may include unit phoneme information and information on a combination of unit phoneme information. Accordingly, the utterance recognition module may convert user's utterance (voice input) into text data using information regarding vocalization and information related to a unit phoneme.

The natural language understanding module 552 may perform a similar function to that of the natural language understanding module 223 of FIG. 1. The natural language understanding module 552 may understand an intention of a user using text data of a voice input. For example, the natural language understanding module 552 may understand the user's intention by performing syntactic analysis or semantic analysis with respect to the text data. According to an embodiment, the natural language understanding module 552 may understand a meaning of a word extracted from the text data using linguistic characteristics (for example, grammatical elements) of a morpheme or a phrase, and may determine the user's intention by matching the understood meaning of the word with the intention.

The dialogue manager 553 may perform a similar function to that of the planner module 225 of FIG. 1. The dialogue manager 553 may generate a plan using the intention determined at the natural language understanding module 552, and a parameter (referred to as a slot, a tag, or metadata). According to an embodiment, the dialogue manager 553 may determine a plurality of domains necessary for performing a task (or function) based on the determined intention. The dialogue manager 553 may determine a plurality of operations (actions) included in the plurality of domains, respectively, which are determined based on the intention. According to an embodiment, the dialogue manager 553 may determine a parameter necessary for executing the determined plurality of operations, or a resulting value output by execution of the plurality of operations. The parameter and the resulting value may be defined as a concept of a designated format (or class). Accordingly, the plan may include the plurality of operations and a plurality of concepts which are determined by the user's intention. The dialogue manager 553 may determine a relationship between the plurality of operations and the plurality of concepts in stages (or hierarchically). For example, the dialogue manager 553 may determine an execution order of the plurality of operations, which are determined based on the user's intention, based on the plurality of concepts. In other words, the dialogue manager 553 may determine the execution order of the plurality of operations, based on the parameter necessary for executing the plurality of operations and the result output by execution of the plurality of operations. Accordingly, the dialogue manager 553 may generate the plan including relation information (for example, ontology) between the plurality of operations and the plurality of concepts.

According to an embodiment, the dialogue manager 553 may generate the plan using information that is stored in a capsule database (for example, the capsule database 230 of FIG. 1) in which a set of relationships between concepts and operations is stored. The capsule database may include a dialogue registry in which information of dialogue (or interaction) with the user is stored. The dialogue registry may include a pre-defined template which is matched with the user's intention and the parameter. The template may be a format of a response that is provided according to a user's intention and is stored in the form of an incomplete sentence, and may be a sentence that is completed by filling (or substituting) an element (for example, a parameter) portion included in the template.

The dialogue manager 553 may control a flow of dialogue with the user, based on the user's intention and the parameter which are determined as the result of analyzing the user's voice input. Herein, the flow of dialogue may refer to a series of processes for determining how the electronic device 500 responds to user's utterance. In this case, the dialogue manager 553 may define a method of defining the flow of dialogue as a state and generating and outputting a response as a policy. When determining the policy of the response, the dialogue manager 553 may determine whether to provide (generate or output) the response based on user's preference information 561a. To achieve this, the dialogue manager 553 may include a user preference identification module 553a.

The user preference identification module 553a may determine whether to provide the response, based on the user's preference information 561a. The case in which the response is provided based on the user's preference information 561a may include a case in which a response accompanied by retrieval of information included in the result of analyzing the user's voice input is provided. For example, the type of the response may include at least one of a response of an information providing type which has a purpose of providing information, a response of a request type which requests information necessary for performing a function according to the user's intention (for example, a parameter necessary for responding), and a response of a chitchat type. Herein, the case of the response of the information providing type may be included in the case in which the response is provided based on the user's preference information 561a. For example, when providing a result of retrieving information as a response to the user's voice input, the electronic device 500 may generate and output the response using information preferred by the user in retrieval data 581.

According to an embodiment, the user preference identification module 553a may determine whether to provide the response by retrieving information, based on the user's intention. For example, when the type of the response determined based on the user's intention is the response of the information providing type, the user preference identification module 553a may determine to provide the response by retrieving information. According to an embodiment, the user preference identification module 553a may identify the type of the response matched with the user's intention, based on information regarding the types of the responses matched with intentions of the user, and may determine whether to provide the response by retrieving information, based on the identified type of the response. The information regarding the types of the responses matched with the intensions of the user may be pre-stored in the memory 540.

According to an embodiment, the user preference identification module 553a may determine whether to provide the response by retrieving information, based on a type of an action (or operation) for providing the response. The action may be determined by the dialogue manager 553, and the dialogue manager 553 may determine an action included in a domain (for example, an application) which is determined based on the user's intention. For example, the action may include an operation for performing a function of an application. The type of the action may be the same as or similar to the type of the response if the action is limited to the dialogue with the user. For example, the type of the action may include at least one of an action of an information providing type for performing an information providing function, an action of a request type for performing a function of requesting information necessary for performing a function according to a user's intention (for example, a parameter necessary for responding), and an action of a chitchat type for performing a chitchat function. When the type of the action is the action of the information providing type, the user preference identification module 553a may determine to provide the response by retrieving information.

According to an embodiment, the user preference identification module 553a may determine whether to provide the response by retrieving information, based on a feature of an element (for example, a parameter) of the response. For example, when the feature of the element coincides with information reflecting user's preference based on the user's preference information 561a, the user preference identification module 553a may determine to provide the response by retrieving information. According to an embodiment, when the feature of the element is the same as or similar to a feature of at least some piece of information included in the user's preference information 561a, the user preference identification module 553a may determine to provide the response by retrieving information.

When it is determined that the response is provided by retrieving information, the dialogue manager 553 may request the information retrieval module 554 to retrieve information, and may acquire the retrieved data 581 as a result of retrieving the information from the information retrieval module 554. When the retrieved data 581 is acquired from the information retrieval module 554, the dialogue manager 553 may transmit the acquired retrieval data 581 and the user's preference information 561a to the natural language generator module 555, along with data necessary for generating the response (for example, data indicating the type of the response).

When it is determined that the response is provided without retrieving information, the dialogue manager 553 may transmit the data necessary for generating the response (for example, data indicating the type of the response) to the natural language generator module 555.

According to an embodiment, the dialogue manager 553 may acquire the user's preference information 561a from a user account portal 560. The user account portal 560 may include a user preference information database (DB) 561 in which the user's preference information 561a is stored. The user account portal 560 may acquire personalization information stored in a personalization information database 571 of a personal information storage device 570, and may synchronize the acquired personalization information and the user's preference information 561a which is stored in the user preference information database 561. The personal information storage device 570 may include a device used by the user, for example, the electronic device 500. The personal information storage device 570 may include an external storage device. According to an embodiment, the dialogue manager 553 may acquire the user's preference information 561a using the personalization information acquired from the personal information storage device 570. The user's preference information 561a may be information that is acquired by learning information acquired through interaction with the user through an AI-based learning model.

The information retrieval module 554 may retrieve information through a data portal 580, and may transmit the retrieval data 581 which is acquired as a result of retrieving the information to the dialogue manager 553. The data portal 580 may include, for example, a relational database included in the electronic device 500 or an external data server connected through a communication circuit. The retrieval data 581 may include structured data or unstructured data. The structured data may be data that is simplified according to a designated format. For example, the structured data may include data indicating state information of a designated object according to time, or data of each category. The data indicating the state information of the designated object according to time may include, for example, data indicating state information of each team in a game according to time, like game result data. The data of each category may include data indicating information of each category, such as a crew (for example, a director or an actor) of a movie, a rating of the movie, or a genre of the movie, like movie search data. The unstructured data may be data that does not conform to a designated format. For example, the unstructured data may be comprised of at least one sentence such as a news article. According to an embodiment, the information retrieval module 554 may generate the structured data using the unstructured data.

The natural language generator module 555 may perform a similar function to that of the natural language generator module 227 of FIG. 1. The natural language generator module 555 may change designated information to a text form. The information changed to the text form may be a form of natural language utterance. The designated information may include, for example, information for guiding completion of an operation (or performance of a function) corresponding to a voice input by user utterance, or information for guiding an additional input of a user (for example, feedback information as to a user input). That is, the designated information may be included in the response that is generated in response to the user's voice input.

The natural language generator module 555 may generate the response based on data transmitted from the dialogue manager 553. To achieve this, the natural language generator module 555 may include a feature information extraction module 555a, a response generation module 555b, and a response correction module 555c. When the natural language generator module 555 receives the retrieval data 581 and the user's preference information 561a from the dialogue manager 553, along with data necessary for generating the response (for example, data indicating the type of the response), the natural language generator module 555 may transmit the retrieval data 581 and the user's preference information 561a to the feature information extraction module 555a. In addition, when the natural language generator module 555 receives only the data necessary for generating the response (for example, the data indicating the type of the response) from the dialogue manager 553, the natural language generator module 555 may transmit the data necessary for generating the response to the response generation module 555b.

The feature information extraction module 555a may extract feature information (or important information) from the retrieval data 581, based on the user's preference information 561a. According to an embodiment, the feature information extraction module 555a may give a weight (for example, give a score) to at least one piece of information included in the retrieval data 581, based on the user's preference information 561a. In addition, the feature information extraction module 555a may extract the feature information from the retrieval data 581, based on the given weight. For example, the feature information extraction module 555a may give a score to information that fits with user's preference (for example, a sport team, a player, food, a movie genre, a director, an actor, or a region, etc.) in the retrieval data 581, and may select and extract the feature information from the retrieval data 581, based on the given score. The feature information extraction module 555a may transmit the feature information to the response generation module 555b.

According to an embodiment, when the extracted feature information includes a plurality of pieces of information, the feature information extraction module 555a may set priority of the plurality of pieces of information, based on weights (for example, scores) given to the plurality of pieces of information, respectively. For example, the feature information extraction module 555a may set high priority for information given the high weight. The priority may be used in determining an arrangement order of the plurality of pieces of information included in the response. The feature information extraction module 555a may transmit information on the priority of the feature information to the response generation module 555b along with the feature information.

The response generation module 555b may generate the response to the user's voice input. The response generation module 555b may determine whether to generate the response using the template or whether to generate the response based on the user's preference information 561a. According to an embodiment, when the response generation module 555b does not receive the feature information (and the information on the priority of the feature information) from the feature information extraction module 555a (when the natural language generator module 555 receives only the data necessary for generating the response from the dialogue manager 553), the response generation module 555b may generate the response using the template. According to an embodiment, when the response generation module 555b receives the feature information (and the information on the priority of the feature information) from the feature information extraction module 555a (when the natural language generator module 555 receives the retrieval data 581 and the user's preference information 561a from the dialogue manager 553 along with the data necessary for generating the response), the response generation module 555b may generate the response based on the user's preference information 561a, without using the template.

The case in which the response is generated using the template may include the case in which the response is provided without retrieving information. When the response is generated using the template, the response generation module 555b may identify (or search) the template based on a user's intention. When the template is identified, the response generation module 555b may generate the response with a sentence that is completed by filling an element (parameter) portion in the template.

The case in which the response is generated based on the user's preference information (without using the template) may include the case in which the response is provided by retrieving information. When the response is generated based on the user's preference information 561a, the response generation module 555b may generate the response to include at least one piece of information of the extracted feature information. According to an embodiment, the response generation module 555b may generate the response using only the feature information in the information included in the retrieval data 581. In this case, additional information except for the feature information in the information included in the retrieval data 581 may be excluded from the response.

According to an embodiment, when the feature information includes a plurality of pieces of information and information regarding the priority of the feature information is received from the feature information extraction module 555a along with the feature information, the response generation module 5 may generate the response using the plurality of pieces of information, based on the priority. For example, when each of a plurality of elements of the response corresponds to any one of the plurality of pieces of information, the response generation module 555b may determine an arrangement order of the plurality of elements based on the priority of the plurality of pieces of information. For example, the response generation module 555b may arrange information of the high priority on a head portion of the response so as to be output first.

The response correction module 555c may correct the response generated by the response generation module 555b. The response correction module 555c may identify whether the generated response conforms to grammar and/or a meaning, and, when the generated response does not conform to the grammar and/or meaning, the response correction module 555c may correct the generated response. In addition, when there exists the feature information, the response correction module 555c may identify whether the feature information is included in the generated response, and, when the feature information is not included in the generated response, the response correction module 555c may correct the generated response to include the feature information. In addition, when there exist the feature information and the information on the priority of the feature information, the response correction module 555c may identify whether the feature information included in the generated response is arranged according to the priority, and, when the feature information is arranged regardless of the priority, the response correction module 555c may correct the generated response such that the feature information is arranged according to the priority.

The text-to-speech conversion module 556 may perform a similar function to that of the text-to-speech conversion module 229 of FIG. 1. The text-to-speech conversion module 556 may change information of a text form (for example, text data) to information of a voice form (for example, voice data). For example, the text-to-speech conversion module 556 may receive information of a text form from the natural language generator module 555, and may change the information of the text form to information of a voice form and may output the information through the output device 520 (for example, a speaker).

According to various example embodiments as described above, an electronic device (for example, the electronic device 500) may include: a microphone (for example, the microphone 510), an output device comprising output circuitry (for example, the output device 520), and a processor (for example, the processor 530) operatively connected with the microphone and the output device, and the processor may be configured to: analyze a voice input acquired through the microphone, based on a result of analyzing the voice input, determine whether to provide a response by retrieving information included in the result of analyzing the voice input, based on a determination to provide the response by retrieving the information, acquire data by retrieving the information, based on preference information, extract feature information from the acquired data, generate the response to include at least one piece of information of the extracted feature information, and control the output device to output the generated response.

According to various example embodiments, the processor may be configured to determine an intention of the user as to the voice input, based on the result of analyzing the voice input, and to determine whether to provide the response by retrieving the information, based on the determined intention of the user.

According to various example embodiments, the electronic device may further include: a memory (for example, the memory 540) configured to store information related to types of the response which are matched with intentions of the user, and the processor may be configured to: identify a type of the response matched with the determined intention of the user, based on the information related to types of the response, and to determine whether to provide the response by retrieving the information, based on the identified type of the response.

According to various example embodiments, the processor may be configured to: determine a type of an action for providing the response, based on the result of analyzing the voice input, and determine whether to provide the response by retrieving the information, based on the determined type of the action.

According to various example embodiments, the processor may be configured to: determine a feature of an element of the response, based on the result of analyzing the voice input, and determine whether to provide the response by retrieving the information, based on the determined feature of the element.

According to various example embodiments, the processor may be configured to: give a weight to at least one piece of information included in the acquired data, based on the preference information of the user, and extract the feature information from the acquired data, based on the given weight.

According to various example embodiments, the processor may be configured to, based on the extracted feature information including a plurality of pieces of information, set priority of the plurality of pieces of information, based on the weight given to each of the plurality of pieces of information, and to generate the response using the plurality of pieces of information, based on the set priority.

According to various example embodiments, the processor may be configured to: generate the response such that each of a plurality of elements of the response corresponds to any one of the plurality of pieces of information, and determine an arrangement order of the plurality of elements, based on the set priority.

According to various example embodiments as described above, an electronic device may include: a communication circuit and a processor operatively connected with the communication circuit, and the processor may be configured to: acquire a voice input from an external electronic device connected through the communication circuit, analyze the acquired voice input, determine whether to provide a response by retrieving information included in a result of analyzing the acquired voice input, based on the result of analyzing the acquired voice input, based on a determination to provide the response by retrieving the information, acquire data by retrieving the information, extract feature information from the acquired data, based on preference information, generate the response to include at least one piece of information of the extracted feature information, and control the communication circuit to transmit the generated response to the external electronic device.

According to various example embodiments, the processor may be configured to: based on the result of analyzing the voice input, determine at least one of an intention of the user as to the voice input, a type of an action for providing the response, and a feature of an element of the response, and, based on at least one of the intention of the user, the type of the action, and the feature of the element, determine whether to provide the response by retrieving the information.

According to various example embodiments, the processor may be configured to give a weight to at least one piece of information included in the acquired data, based on the preference information of the user, and to extract the feature information from the acquired data, based on the given weight.

According to various example embodiments, the processor may be configured to, based on the extracted feature information including a plurality of pieces of information, set priority of the plurality of pieces of information, based on the weight given to each of the plurality of pieces of information, and to generate the response using the plurality of pieces of information based on the set priority.

According to various example embodiments, the processor may be configured to generate the response such that each of a plurality of elements of the response corresponds to any one of the plurality of pieces of information, and to determine an arrangement order of the plurality of elements, based on the set priority.

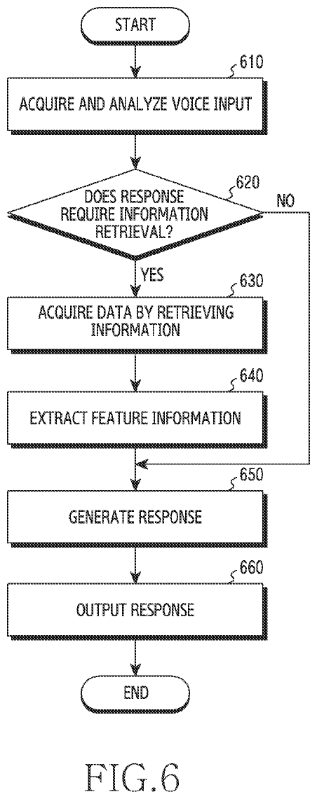

FIG. 6 is a flowchart illustrating an example method for providing a response to a voice input according to various embodiments.

Referring to FIG. 6, in operation 610, a processor (for example, the processor 530 of FIG. 4) of an electronic device (for example, the electronic device 500 of FIG. 4) may acquire and analyze a voice input. According to an embodiment, the processor may acquire a voice input by user's utterance through a microphone (for example, the microphone 510 of FIG. 4). According to an embodiment, the processor 530 may acquire a user's voice input from an external electronic device connected through a communication circuit.

The processor 530 may analyze the acquired voice input. For example, the processor 530 may convert the voice input into text data through an automatic speech recognition module (for example, the automatic speech recognition module 551 of FIG. 4), and may understand a user's intention using the converted text data through a natural language understanding module (for example, the natural language understanding module 552 of FIG. 4), and may identify a parameter necessary for generating a response.

In operation 620, the processor 530 may determine whether the response that should be provided in response to the voice input is a response requiring information retrieval. For example, the processor 530 may determine whether the response is the response requiring information retrieval through a dialogue manager (for example, the dialogue manager 553 of FIG. 4).

According to an embodiment, the processor 530 may determine whether to provide the response by retrieving information, based on the user's intention. For example, when the type of the response determined based on the user's intention is a response of an information providing type, the processor 530 may determine to provide the response by retrieving information. In this case, the processor 530 may identify the type of the response matched with the user's intention, based on information on the types of the responses matched with intentions of the user, and may determine whether to provide the response by retrieving information based on the identified type of the response. The information on the types of the responses matched with the intentions of the user may be pre-stored in a memory (for example, the memory 540 of FIG. 4).

According to an embodiment, the processor 530 may determine whether to provide the response by retrieving information, based on a type of an action (or operation) for providing the response. For example, when the type of the action is an action of an information providing type, the processor 530 may determine to provide the response by retrieving information.

According to an embodiment, the processor 530 may determine whether to provide the response by retrieving information, based on a feature of an element (for example, a parameter) of the response. For example, when the feature of the element is the same as or similar to a feature of at least some piece of information included in user's preference information (for example, the user's preference information 561a of FIG. 5), the processor 530 may determine to provide the response by retrieving information.

When the response is not the response requiring retrieval of information (No in operation 620), the processor 530 may generate the response using a template in operation 650. The template may be a format of a response that is provided according to a user's intention and is pre-stored in the form of an incomplete sentence, and may be a sentence that is completed by filling (or substituting) an element (for example, a parameter) portion included in the template. For example, the processor 530 may identify (or search) the template based on the user's intention, and may generate the response with a sentence that is completed by filling the element portion in the identified template. In addition, when the response is generated, the processor 530 may output the generated response through an output device (for example, the output device 520 of FIG. 4) in operation 660. For example, the processor 530 may output the response generated in a voice form through a speaker. In another example, the processor 530 may output the response generated in a visual form (for example, a text or an image) through a display. In still another example, the processor 530 may convert the response into data of a voice form and output the response through the speaker, or may convert the response into data of a visual form and may output the response through the display.

When the response is the response requiring retrieval of information (Yes in operation 620), the processor 530 may acquire data by retrieving information in operation 630. For example, the processor 530 may acquire retrieval data (for example, the retrieval data 581 of FIG. 5) by retrieving information through an information retrieval module (for example, the information retrieval module 554 of FIG. 4). In addition, the processor 530 may acquire user preference information (for example, the user preference information 561a of FIG. 5) from at least one of a user account portal (for example, the user account portal 560 of FIG. 5) or a personal information storage device (for example, the personal information storage device 570 of FIG. 5).

When the retrieval data and the user preference information are acquired, the processor 530 may extract feature information from the retrieval data based on the user preference information in operation 640. For example, the processor 530 may extract the feature information from the retrieval data based on the user preference information through a natural language generator module (for example, the natural language generator module 555 of FIG. 4).

According to an embodiment, the processor 530 may give a weight (for example, give a score) to at least one piece of information included in the retrieval data, based on the user preference information. In addition, the processor 530 may extract the feature information from the retrieval data, based on the given weight.

According to an embodiment, when the extracted feature information includes a plurality of pieces of information, the processor 530 may set priority of the plurality of pieces of information, based on weights (for example, scores) given to the plurality of pieces of information, respectively. For example, the processor 530 may set high priority for information having the high weight.

When the feature information is extracted, the processor 530 may generate the response to include at least one piece of information of the extracted feature information in operation 650. According to an embodiment, the processor 530 may generate the response using only the feature information in the information included in the retrieval data. In this case, additional information except for the feature information in the information included in the retrieval data may be excluded from the response.

According to an embodiment, when the extracted feature information includes the plurality of pieces of information and the priority is set for the extracted feature information, the processor 530 may generate the response using the plurality of pieces of information based on the priority. For example, when each of a plurality of elements of the response corresponds to any one of the plurality of pieces of information, the processor 530 may determine an arrangement order of the plurality of elements, based on the priority of the plurality of pieces of information. For example, the processor 530 may arrange information of high priority on a head portion of the response to be output first.

When the response is generated, the processor 530 may output the generated response through the output device in operation 660. For example, the processor 530 may output the response generated in a voice form through the speaker. In another example, the processor 530 may output the response generated in a visual form through the display. In still another example, the processor 530 may convert the response into data of a voice form and may output the response through the speaker, or may convert the response into data of a visual form and may output the response through the display.

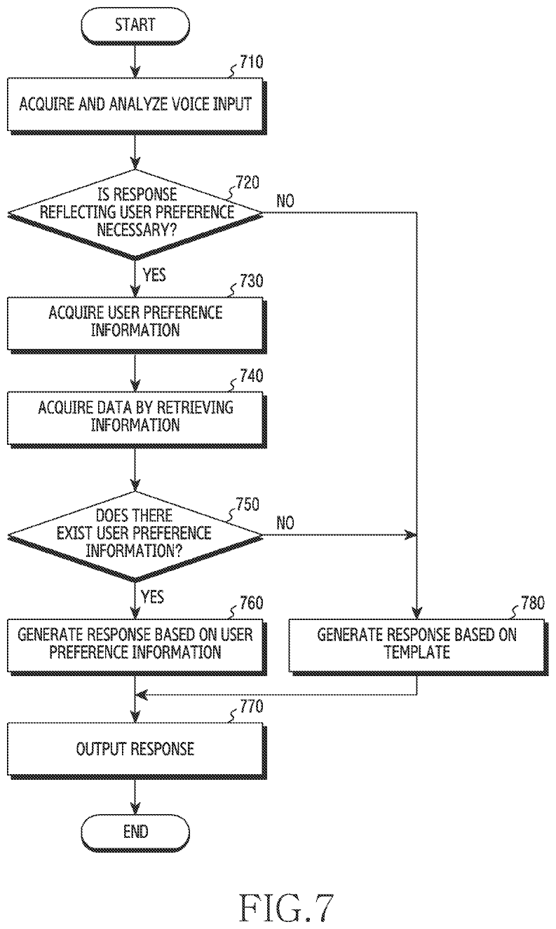

FIG. 7 is a flowchart illustrating an example method for providing a response to a voice input according to various embodiments.

Referring to FIG. 7, in operation 710, a processor (for example, the processor 530 of FIG. 4) of an electronic device (for example, the electronic device 500 of FIG. 4) may acquire and analyze a voice input. According to an embodiment, the processor 530 may acquire a voice input by user's utterance through a microphone (for example, the microphone 510 of FIG. 4). According to an embodiment, the processor 530 may acquire a user's voice input from an external electronic device connected through a communication circuit.

The processor 530 may analyze the acquired voice input. For example, the processor 530 may convert the voice input into text data through an automatic speech recognition module (for example, the automatic speech recognition module 551 of FIG. 4), and may understand a user's intention using the converted text data through a natural language understanding module (for example, the natural language understanding module 552 of FIG. 4), and may identify a parameter necessary for generating a response.

In operation 720, the processor 530 may determine whether a response reflecting user's preference is necessary. For example, the processor 530 may determine whether the response reflecting the user's preference is necessary, through a dialogue manager (for example, the dialogue manager 553 of FIG. 4). The case in which the response reflecting the user's preference is necessary may include, for example, a case in which a response accompanied by retrieval of information included in the result of analyzing the user's voice input is provided.

According to an embodiment, the processor 530 may determine whether the response reflecting the user's preference is necessary, based on the user's intention. For example, when the type of the response determined based on the user's intention is a response of an information providing type, the processor 530 may determine to provide the response reflecting the user's preference. In this case, the processor 530 may identify the type of the response matched with the user's intention, based on information on the types of the responses matched with intensions of the user, and may determine whether the response reflecting the user's preference is necessary, based on the identified type of the response. The information on the types of the responses matched with the intentions of the user may be pre-stored in a memory (for example, the memory 540 of FIG. 4).

According to an embodiment, the processor 530 may determine whether the response reflecting the user's preference is necessary, based on a type of an action (or an operation) for providing the response. For example, when the type of the action is an action of an information providing type, the processor 530 may determine to provide the response reflecting the user's preference.

According to an embodiment, the processor 530 may determine whether the response reflecting the user's preference is necessary, based on a feature of an element (for example, a parameter) of the response. For example, when the feature of the element is the same as or similar to a feature of at least some piece of information included in user's preference information (for example, the user's preference information 561a of FIG. 5), the processor 530 may determine to provide the response reflecting the user's preference.

When it is determined that the response reflecting the user's preference is not necessary (No in operation 720), the processor 530 may generate the response based on a template in operation 780. For example, the processor 530 may identify (or search) the template based on a user's intention through a natural language generator module (for example, the natural language generator module 555 of FIG. 4), and may generate the response with a sentence that is completed by filling the element portion in the identified template. In addition, when the response is generated, the processor 530 may output the generated response through an output device (for example, the output device 520 of FIG. 4) in operation 770. For example, the processor 530 may output the response generated in a voice form through a speaker. In another example, the processor 530 may output the response generated in a visual form (for example, a text or an image) through a display. In still another example, the processor 530 may convert the response into data of a voice form and output the response through the speaker, or may convert the response into data of a visual form and may output the response through the display.

When it is determined that the response reflecting the user's preference is necessary (Yes in operation 720), the processor 530 may acquire user preference information (for example, the user preference information 561a of FIG. 5) in operation 730. According to an embodiment, the processor 530 may acquire the user preference information from at least one of a user account portal (for example, the user account portal 560 of FIG. 5) or a personal information storage device (for example, the personal information storage device 570 of FIG. 5).

In operation 740, the processor 530 may acquire data by retrieving information. For example, the processor 530 may acquire retrieval data (for example, the retrieval data 581 of FIG. 5) by retrieving information through an information retrieval module (for example, the information retrieval module 554 of FIG. 4).

When the retrieval data and the user preference information are acquired, the processor 530 may determine whether there exists the user preference information in the retrieval data in operation 750. For example, the processor 530 may determine whether there exists information that has the same or similar feature as or to a feature of at least some piece of information included in the user preference information in the information included in the retrieval data.

When the user preference information in the retrieval data does not exist (No in operation 750), the processor 530 may generate the response based on the template in operation 780.

When the user preference information in the retrieval data exists (Yes in operation 750), the processor 530 may generate the response based on the user preference information in operation 760. For example, the processor 530 may extract feature information from the retrieval data based on the user preference information through the natural language generator module, and may generate the response to include at least one piece of information of the extracted feature information. According to an embodiment, the processor 530 may generate the response using only the feature information in the information included in the retrieval data. In this case, additional information except for the feature information in the information included in the retrieval data may be excluded from the response.

According to an embodiment, the processor 530 may give a weight (for example, give a score) to at least one piece of information included in the retrieval data, based on the user preference information. In addition, the processor 530 may extract the feature information from the retrieval data, based on the given weight.

According to an embodiment, when the extracted feature information includes a plurality of pieces of information, the processor 530 may set priority of the plurality of pieces of information, based on weights (for example, scores) given to the plurality of pieces of information, respectively. For example, the processor 530 may set high priority for information having the high weight.

According to an embodiment, when the extracted feature information includes the plurality of pieces of information and the priority is set for the extracted feature information, the processor 530 may generate the response using the plurality of pieces of information based on the priority. For example, when each of a plurality of elements of the response corresponds to any one of the plurality of pieces of information, the processor 530 may determine an arrangement order of the plurality of elements, based on the priority of the plurality of pieces of information. For example, the processor 530 may arrange information of high priority on a head portion of the response to be output first.

When the response is generated, the processor 530 may output the generated response through the output device in operation 770. For example, the processor 530 may output the response generated in a voice form through the speaker. In another example, the processor 530 may output the response generated in a visual form through the display. In still another example, the processor 530 may convert the response into data of a voice form and may output the response through the speaker, or may convert the response into data of a visual form and may output the response through the display.

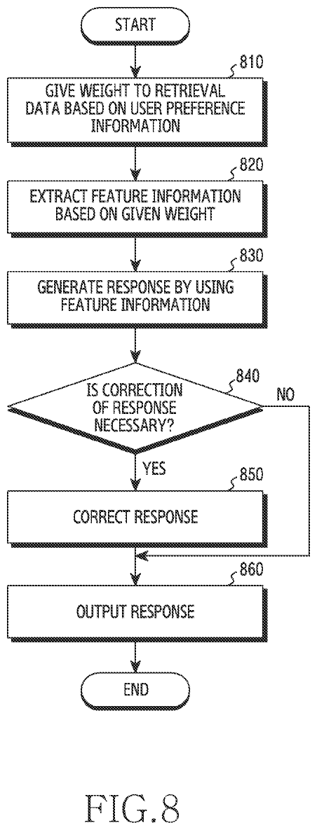

FIG. 8 is a flowchart illustrating an example method for generating and correcting a response based on user's preference according to various embodiments.

Referring to FIG. 8, in operation 810, a processor (for example, the processor 530 of FIG. 4) of an electronic device (for example, the electronic device 500 of FIG. 4) may give a weight to retrieval data (for example, the retrieval data 581 of FIG. 5), based on user preference information (for example, the user's preference information 561a of FIG. 5). For example, the processor 530 may give a score (weight) to at least one piece of information included in the retrieval data, based on the user preference information.

In operation 820, the processor 530 may extract feature information from the retrieval data based on the given weight. For example, the processor 530 may set, as the feature information, information that has a weight greater than or equal to a designated value in the information included in the retrieval data, and may extract the feature information from the retrieval data.

According to an embodiment, when the extracted feature information includes a plurality of pieces of information, the processor 530 may set priority of the plurality of pieces of information, based on weights (for example, scores) given to the plurality of pieces of information, respectively. For example, the processor 530 may set high priority for information having the high weight.

In operation 830, the processor 530 may generate a response using the extracted feature information. For example, the processor 530 may generate the response to include at least one piece of information of the extracted feature information. According to an embodiment, the processor 530 may generate the response using only the feature information in the information included in the retrieval data. In this case, additional information except for the feature information in the information included in the retrieval data may be excluded from the response.

In operation 840, the processor 530 may determine whether the generated response needs to be corrected. According to an embodiment, the processor 530 may identify whether the generated response conforms to grammar and/or meaning, and, when the generated response does not conform to grammar and/or meaning, the processor 530 may determine that correction is necessary. According to an embodiment, the processor 530 may identify whether the generated response includes the feature information, and, when the generated response does not include the feature information, the processor 530 may determine that correction is necessary. According to still an embodiment, when priority is set for the feature information, the processor 530 may identify whether the feature information included in the generated response is arranged according to the priority, and, when the feature information is arranged regardless of the priority, the processor 530 may determine that correction is necessary.

When it is determined that the correction of the generated response is necessary (Yes in operation 840), the processor 530 may correct the generated response in operation 850. According to an embodiment, when the generated response does not conform to grammar and/or meaning, the processor 530 may correct the generated response to conform to grammar and/or meaning. According to an embodiment, when the generated response does not include the feature information, the processor 530 may correct the generated response to include the feature information. According to still an embodiment, when the feature information included in the generated response is arranged regardless of the priority, the processor 530 may correct the generated response such that the feature information is arranged according to the priority. Thereafter, the processor 530 may output the corrected response through an output device in operation 860.

When it is determined that the correction of the generation response is not necessary (No in operation 840), the processor 530 may output the generated response through the output device in operation 860. For example, the processor 530 may output the response generated in a voice form through the speaker. In another example, the processor 530 may output the response generated in a visual form through the display. In still another example, the processor 530 may convert the response into data of a voice form and may output the response through the speaker, or may convert the response into data of a visual form and may output the response through the display.

According to various example embodiments as described above, a method for providing a response to a voice input may include: acquiring and analyzing a voice input (for example, operation 610), based on a result of analyzing the voice input, determining whether to provide a response by retrieving information included in the result of analyzing the voice input (for example, operation 620), based on a determination to provide the response by retrieving the information, acquiring data by retrieving the information (for example, operation 630), based on preference information, extracting feature information from the acquired data (for example, operation 640), generating the response to include at least one piece of information of the extracted feature information (for example, operation 650), and outputting the generated response (for example, operation 660).

According to various example embodiments, determining whether to provide the response by retrieving the information may include: determining an intention of the user as to the voice input, based on the result of analyzing the voice input, and determining whether to provide the response by retrieving the information, based on the determined intention of the user.

According to various example embodiment, determining whether to provide the response by retrieving the information, based on the determined intention of the user may include: identifying a type of the response that is matched with the determined intention of the user, based on information related to types of the response which are matched with intentions of the user, and determining whether to provide the response by retrieving the information, based on the identified type of the response.

According to various example embodiments, determining whether to provide the response by retrieving the information may include: determining a type of an action for providing the response, based on the result of analyzing the voice input, and determining whether to provide the response by retrieving the information, based on the determined type of the action.

According to various example embodiments, determining whether to provide the response by retrieving the information may include: determining a feature of an element of the response, based on the result of analyzing the voice input, and determining whether to provide the response by retrieving the information, based on the determined feature of the element.

According to various example embodiments, extracting the feature information from the acquired data may include: giving a weight to at least one piece of information included in the acquired data, based on the preference information of the user (for example, operation 810), and extracting the feature information from the acquired data, based on the given weight (for example, operation 820).

According to various example embodiments, generating the response may include: based on the extracted feature information including a plurality of pieces of information, setting priority of the plurality of pieces of information, based on the weight given to each of the plurality of pieces of information, determining an arrangement order of a plurality of elements corresponding to the plurality of pieces of information, respectively, based on the set priority, and generating the response to include the plurality of elements based on the arrangement order of the plurality of elements.

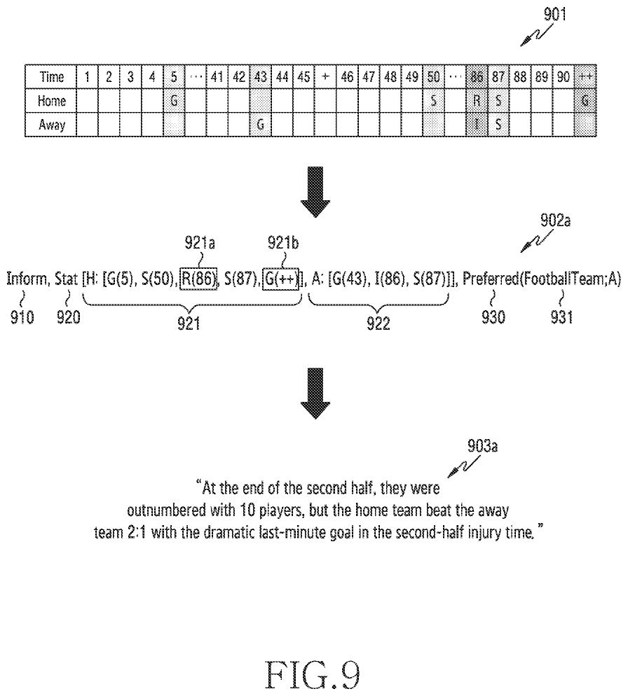

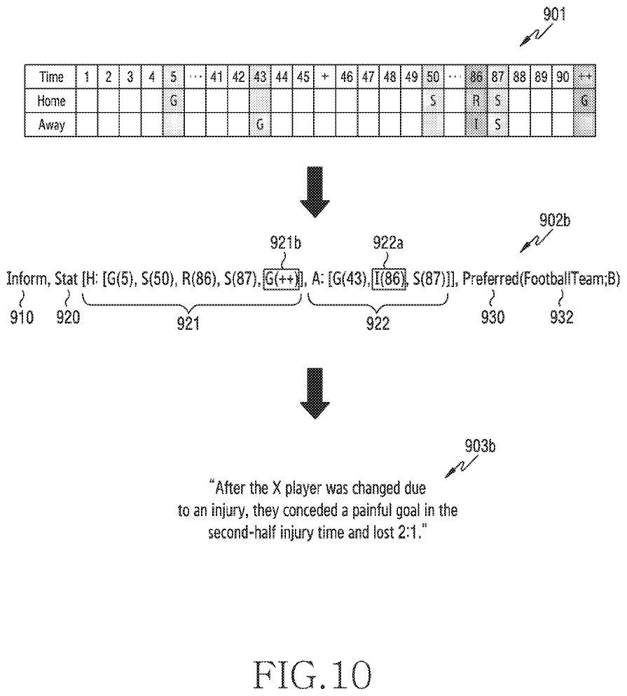

FIG. 9 is a diagram illustrating an example method for generating a response based on user's preference using structured retrieval data according to various embodiments, and FIG. 10 is a diagram illustrating an example method for generating a response based on user's preference using structured retrieval data according to various embodiments.

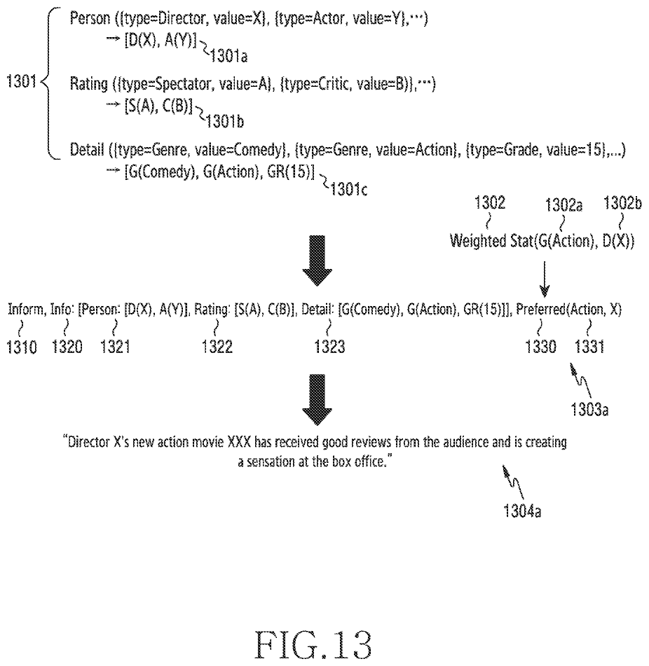

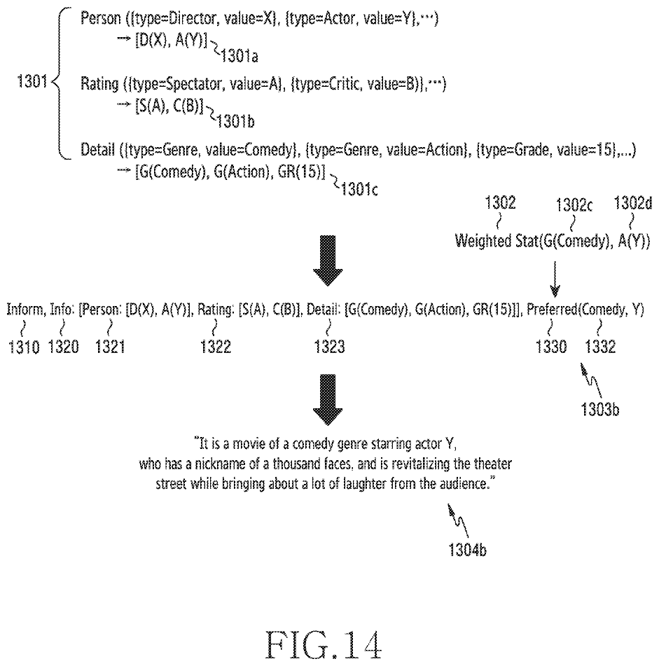

Referring to FIGS. 9 and 10, in a process of generating a response by retrieving information, retrieval data 901 (for example, the retrieval data 581 of FIG. 5) may include structured data (for example, retrieval data 901 of FIGS. 9 and 10 or retrieval data 1301 of FIGS. 13 and 14). The structured data may include data that is simplified according to a designated format. For example, the structured data may include data indicating state information of a designated object according to time, or data of each category. The data indicating the state information of the designated object according to time may include, for example, data indicating state information of each team in a game according to time, such as game result data, as shown in FIGS. 9 and 10. The data of each category may include, for example, data indicating information of each category, such as a crew of a movie (for example, a director or an actor), a rating of the movie, or a genre of the movie, like movie information search data, as illustrated, for example, in FIGS. 13 and 14.

A processor (for example, the processor 530 of FIG. 4) of an electronic device (for example, the electronic device 500 of FIG. 4) may extract feature information from the retrieval data 901, based on user's preference information (for example, the user preference information 561a of FIG. 5). For example, the processor 530 may identify a team that is preferred by the user in a specific sport, based on the user's preference information, and, when a question about the game result is received as a voice input, the processor 530 may select and extract feature information from the retrieval data 901 regarding the game result with reference to an important event (for example, scoring/losing of a point of a team or injury/change/warning/sending-off of a player) related to the team preferred by the user.

When the feature information is extracted from the retrieval data 901, the processor 530 may generate an instruction 902a, 902b for generating a response. The instruction 902a, 902b may be input data that is transmitted to a response generation module (for example, the response generation module 555b of FIG. 4). For example, the response generation module may generate a response when the instruction 902a, 902b is input.

The instruction 902a, 902b may include a type of the response 910, at least one piece of information 920 included in the retrieval data 901, and information 930 preferred by the user in the information 920. The type of the response 910 may include at least one of a response of an information providing type (for example, input as “Inform”) for providing information, a response of a request type (for example, input as “Request”) for requesting information (for example, a parameter necessary for a response) necessary for performing a function according to a user's intention, and a response of a chitchat type (for example, input as “Chitchat”). The at least one piece of information 920 included in the retrieval data 901 may include the state information of the designated object according to time or the information of each category. For example, in retrieval of a sport game result, the information 920 may include state information of each team in the game according to time. In FIGS. 9 and 10, the information 920 may include information 921 related to scoring/losing of a point of a home team according to time and injury/change/warning/sending-out of a player, and information 922 related to scoring/losing of a point of an away team according to time and injury/change/warning/sending-out of a player. The information 930 preferred by the user may include, for example, a name of a team preferred by the user in the retrieval of the sport game result. In FIG. 9, the user prefers an A team (home team) and the information 930 includes a name 931 of the A team, and in FIG. 10, the user prefers a B team (away team) and the information 930 includes a name 932 of the B team.

According to an embodiment, the processor 530 may include, in the instruction 902a, 902b, information regarding the feature information in the at least one piece of information 920 included in the retrieval data 901. For example, when the user prefers the A team (home team) as shown in FIG. 9, the processor 530 may include the information regarding the feature information in the instruction 902a, such that feature information (for example, sending-out information 921a of a player or scoring information 921b of the team) indicating an important event related to the A team preferred by the user is identified in the instruction 902a. In another example, when the user prefers the B team (away team) as shown in FIG. 10, the processor 530 may include the information regarding the feature information in the instruction 902b, such that feature information (for example, injury information 922a of a player or information of losing of a point of the team (or the scoring information 921b of the other team) indicating an important event related to the B team preferred by the user is identified in the instruction 902b.

The processor 530 may generate a response 903a, 903b based on the instruction 902a, 902b. According to an embodiment, the processor 530 may generate the response 903a, 903b based on the information 930 preferred by the user, included in the instruction 902a, 902b. According to an embodiment, the processor 530 may generate the response 903a, 903b, based on information regarding the feature information included in the instruction 902a, 902b. The processor 530 may generate the response 903a, 903b with reference to the information 930 preferred by the user (for example, information of the team preferred by the user). For example, as shown in FIG. 9, the processor 530 may generate a first response 903a using the feature information (for example, sending-out information 921a of the player or scoring information 921b of the team) indicating the important event related to the A team preferred by the user. In another example, as shown in FIG. 10, the processor 530 may generate a second response 903b, which is different from the first response 903a, using the feature information (for example, injury information of a player 922a or information of losing of a point of the team (or scoring information 921b of the other team) indicating the important event related to the B team preferred by the user.

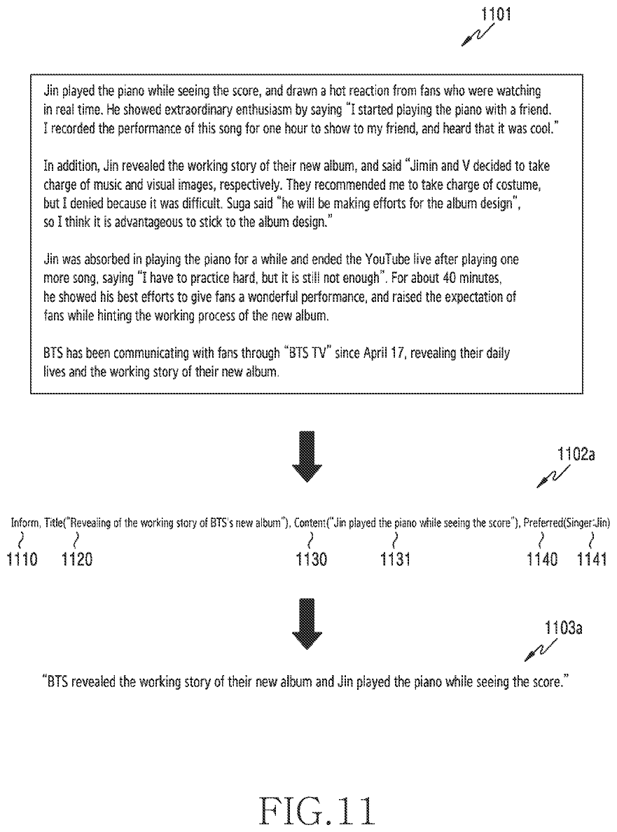

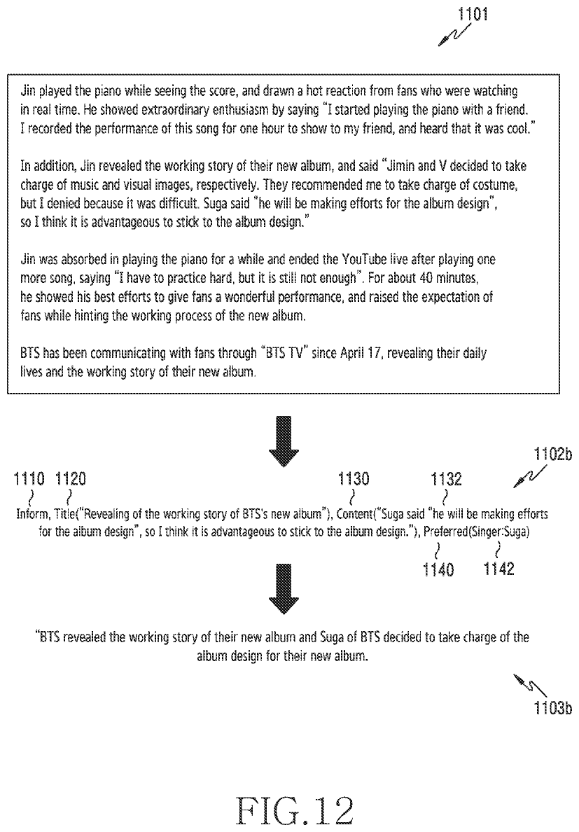

FIG. 11 is a diagram illustrating an example method for generating a response based on user's preference using unstructured retrieval data according to various embodiments, and FIG. 12 is a diagram illustrating an example method for generating a response based on user's preference using unstructured retrieval data according to various embodiments.

Referring to FIGS. 11 and 12, in a process of generating a response by retrieving information, retrieval data 1101 (for example, the retrieval data 581 of FIG. 5) may include unstructured data. The unstructured data may be data that does not conform to a designated format. For example, the unstructured data may be comprised of at least one sentence like a news article. According to an embodiment, a processor (for example, the processor 530 of FIG. 4) of an electronic device (for example, the electronic device 500 of FIG. 4) may generate structured data (for example, the retrieval data 901 of FIGS. 9 and 10 or the retrieval data 1301 of FIGS. 13 and 14) using the unstructured data.

The processor 530 may extract feature information from the retrieval data 1101, based on user's preference information (for example, the user preference information 561a of FIG. 5). For example, the processor 530 may identify a person (for example, a singer) preferred by the user in the news article, based on the user's preference information, and, when a question about the person is received as a voice input, the processor 530 may select and extract feature information from the retrieval data 1101 regarding the person with reference to an important event (for example, production of a singer's album or performance schedule) related to the person preferred by the user.

When the feature information is extracted from the retrieval data 1101, the processor 530 may generate an instruction 1102a, 1102b for generating a response. The instruction 1102a, 1102b may be input data that is transmitted to a response generation module (for example, the response generation module 555b of FIG. 4). For example, the response generation module may generate a response when the instruction 1102a, 1102b is input.

The instruction 1102a, 1102b may include a type of a response 1110, at least one piece of information 1120, 1130 included in the retrieval data 1101, and information 1140 preferred by the user in the information 1120, 1130. The type of the response 1110 may be the same as the type of the response 910 in FIGS. 9 and 10. The at least one piece of information 1120, 1130 included in the retrieval data 1101 may include a title 1120 of the retrieval data 1101 and at least one content 1130 included in the retrieval data 1101. The title 1120 may include, for example, a title of the news article. The content 1130 may include, for example, at least one word, at least one phrase, or at least one sentence included in the news article. According to an embodiment, the processor 530 may select (or extract) the content 1130 from the retrieval data 1101 based on the information 1140 preferred by the user. In this case, the selected (or extracted) content 1130 may include feature information. For example, when the singer preferred by the user is a first person in retrieval of singer information as shown in FIG. 11, the processor 530 may select, as the content 1130, a phrase or a sentence 1131 including a name 1141 (for example, “Jin”) of the first person from the retrieval data 1101. In another example, when the singer preferred by the user is a second person in retrieval of singer information as shown in FIG. 12, the processor 530 may select, as the content 1130, a phrase or a sentence 1132 including a name 1142 (for example, “Suga”) of the second person from the retrieval data 1101. The information 1140 preferred by the user may include, for example, the name of the person preferred by the user in the retrieval of singer information. In FIG. 11, the user prefers the first person and the information 1140 includes the name 1141 of the first person, and in FIG. 12, the user prefers the second person and the information 1140 includes the name 1142 of the second person.

The processor 530 may generate a response 1103a, 1103b based on the instruction 1102a, 1102b. According to an embodiment, the processor 530 may generate the response 1103a, 1103b, based on the information 1140 preferred by the user, included in the instruction 1102a, 1102b. According to an embodiment, the processor 530 may generate the response 1103a, 1103b, based on the content 1130 (corresponding to feature information) included in the instruction 1102a, 1102b. For example, as shown in FIG. 11, the processor 530 may generate a first response 1103a using the phrase or a sentence 1131 including the name 1141 of the first person preferred by the user. In another example, as shown in FIG. 12, the processor 530 may generate a second response 1103b different from the first response 1103a, using the phrase or sentence 1132 including the name 1142 of the second person preferred by the user.

FIG. 13 is a diagram illustrating an example method for generating a response based on a weight given to retrieval data according to various embodiments, and FIG. 14 is a diagram illustrating an example method for generating a response based on a weight given to retrieval data according to various embodiments.

Referring to FIGS. 13 and 14, in a process of generating a response by retrieving information, retrieval data 1301 (for example, the retrieval data 581 of FIG. 5) may include structured data. According to an embodiment, the retrieval data 1301 may include data of each category. The category may include at least one of a person category 1301a (for example, a director or an actor), a rating category 1301b, or a details category 1301c (for example, a genre, a film rating, a production country, a running time, booking information, or comments by critics), like movie information search data shown in FIGS. 13 and 14.

A processor (for example, the processor 530 of FIG. 4) of an electronic device (for example, the electronic device 500 of FIG. 4) may give a weight to at least one piece of information included in the retrieval data 1301, based on user's preference information (for example, the user preference information 561a of FIG. 5). For example, the processor 530 may set important information 1302 to be weighted, based on the user's preference information, and may give a weight to at least one piece of information included in the retrieval data 1301, based on the important information 1302. For example, as shown in FIG. 13, the processor 530 may set a genre 1302a of a movie preferred by the user (for example, “Action” genre) and a movie director 1302b preferred by the user (for example, “X” director) as the important information 1302. In another example, as shown in FIG. 14, the processor 530 may set a genre 1302c of a movie preferred by the user (for example, “Comedy” genre) and a movie actor 1302d (for example, “Y” actor) preferred by the user as the important information 1302. According to an embodiment, the processor 530 may extract feature information from the retrieval data 1301 based on the given weight.

When the important information 1302 is set, the processor 530 may generate an instruction 1303a, 1303b for generating a response. The instruction 1303a, 1303b may be input data that is transmitted to a response generation module (for example, the response generation module 555b of FIG. 4). For example, the response generation module may generate a response when the instruction 1303a, 1303b is input.

The instruction 1303a, 1303b may include a type of a response 1310, at least one piece of information 1320 included in the retrieval data 1301, and information 1330 preferred by the user in the information 1320. The type of the response 1310 may be the same as the type of the response 910 in FIGS. 9 and 10. The at least one piece of information 1320 included in the retrieval data 1301 may include information of each category. For example, in the retrieval of movie information, the information 1320 may include at least one of person information 1321 (for example, a director name or an actor name), rating information 1322 (for example, a rating by a movie viewer or a rating by a critic), or details information 1323 (for example, a genre of the movie or a film rating). In the retrieval of movie information, the information 1330 preferred by the user may include, for example, a genre of a movie, a name of a movie director, or a name of a movie actor which is preferred by the user. In FIG. 13, the user prefers a first genre and a first director, and the information 1330 includes an identifier (for example, “Action”) of the first genre and a name (for example, “X”) 1331 of the first director, and in FIG. 14, the user prefers a second genre and prefers a second actor, the information 1330 may include an identifier (for example, “Comedy”) of the second genre and a name (for example, “Y”) 1332 of the second actor.

According to an embodiment, the processor 530 may include, in the instruction 1303a, 1303b, information on the weight given to at least one piece of information 1320 included in the retrieval data 1301.

The processor 530 may generate a response 1304a, 1304b, based on the instruction 1303a, 1303b. According to an embodiment, the processor 530 may generate the response 1304a, 1304b, based on the information 1330 preferred by the user, included in the instruction 1303a, 1303b. According to an embodiment, the processor 530 may generate the response 1304a, 1304b, based on information on the weight, included in the instruction 1303a, 1303b. The processor 520 may generate the response 1304a, 1304b with reference to the information 1330 preferred by the user (for example, a movie genre or a person preferred by the user). For example, as shown in FIG. 13, the processor 530 may generate a first response 1304a using information on the movie genre and the movie director preferred by the user. In another example, as shown in FIG. 14, the processor 530 may generate a second response 1304b which is different from the first response 1304a, using information on the movie genre and the movie actor preferred by the user.

According to an embodiment, the processor 530 may determine an arrangement order of information included in the response 1304a, 1304b, based on the information on the weight. For example, the processor 530 may set high priority for highly weighted information, and may arrange the information having the high priority on a head portion of the response 1304a, 1304b. FIG. 13 illustrates that the processor 530 arranges information on the movie genre and the movie director preferred by the user on a head portion of the first response 1304a, and FIG. 14 illustrates that the processor 530 arranges information related to the movie genre and the movie actor preferred by the user on a head portion of the second response 1304b.

FIG. 15 is a block diagram illustrating an example electronic device 1501 in a network environment 1500 according to various embodiments. Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In various embodiments, at least one of the components (e.g., the connecting terminal 1578) may be omitted from the electronic device 1501, or one or more other components may be added in the electronic device 1501. In various embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to an embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, a HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to an embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element including a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In an embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. An electronic device comprising:
a microphone;
an output device comprising output circuitry; and
a processor operatively connected with the microphone and the output device,
wherein the processor is configured to:
analyze a voice input acquired through the microphone;
based on a result of analyzing the voice input, determine whether to provide a response by retrieving information included in the result of analyzing the voice input;
based on a determination to provide the response by retrieving the information, acquire data by retrieving the information;
based on preference information, extract feature information from the acquired data;
generate the response to include at least one piece of information of the extracted feature information; and
control the output device to output the generated response.

2. The electronic device of claim 1, wherein the processor is configured to determine an intention of a user as to the voice input based on the result of analyzing the voice input, and to determine whether to provide the response by retrieving the information based on the determined intention of the user.

3. The electronic device of claim 2, further comprising a memory configured to store information related to types of the response matched with intentions of the user,
wherein the processor is configured to identify a type of the response matched with the determined intention of the user based on the information related to types of the response, and to determine whether to provide the response by retrieving the information based on the identified type of the response.

4. The electronic device of claim 1, wherein the processor is configured to determine a type of an action for providing the response based on the result of analyzing the voice input, and to determine whether to provide the response by retrieving the information based on the determined type of the action.

5. The electronic device of claim 1, wherein the processor is configured to determine a feature of an element of the response, based on the result of analyzing the voice input, and to determine whether to provide the response by retrieving the information based on the determined feature of the element.

6. The electronic device of claim 1, wherein the processor is configured to give a weight to at least one piece of information included in the acquired data based on the preference information, and to extract the feature information from the acquired data based on the given weight.

7. The electronic device of claim 6, wherein the processor is configured to, based on the extracted feature information comprising a plurality of pieces of information, set priority of the plurality of pieces of information, based on the weight given to each of the plurality of pieces of information, and to generate the response using the plurality of pieces of information based on the set priority.

8. The electronic device of claim 7, wherein the processor is configured to generate the response such that each of a plurality of elements of the response corresponds to any one of the plurality of pieces of information, and to determine an arrangement order of the plurality of elements based on the set priority.

9. An electronic device comprising:
a communication circuit; and
a processor operatively connected with the communication circuit,
wherein the processor is configured to:
acquire a voice input from an external electronic device connected through the communication circuit;
analyze the acquired voice input;
determine whether to provide a response by retrieving information included in a result of analyzing the acquired voice input based on the result of analyzing the acquired voice input;
based on a determination to provide the response by retrieving the information, acquire data by retrieving the information;
extract feature information from the acquired data based on preference information;
generate the response to include at least one piece of information of the extracted feature information; and
control the communication circuit to transmit the generated response to the external electronic device.

10. The electronic device of claim 9, wherein the processor is configured to:
based on the result of analyzing the voice input, determine at least one of an intention of a user as to the voice input, a type of an action for providing the response, and a feature of an element of the response; and
based on at least one of the intention of the user, the type of the action, and the feature of the element, determine whether to provide the response by retrieving the information.

11. The electronic device of claim 9, wherein the processor is configured to give a weight to at least one piece of information included in the acquired data based on the preference information, and to extract the feature information from the acquired data based on the given weight.

12. The electronic device of claim 11, wherein the processor is configured to, based on the extracted feature information comprising a plurality of pieces of information, set priority of the plurality of pieces of information based on the weight given to each of the plurality of pieces of information, and to generate the response using the plurality of pieces of information based on the set priority.

13. The electronic device of claim 12, wherein the processor is configured to generate the response such that each of a plurality of elements of the response corresponds to any one of the plurality of pieces of information, and to determine an arrangement order of the plurality of elements based on the set priority.

14. A method for providing a response to a voice input, the method comprising:
acquiring and analyzing a voice input;
based on a result of analyzing the voice input, determining whether to provide a response by retrieving information included in the result of analyzing the voice input;
based on a determination to provide the response by retrieving the information, acquiring data by retrieving the information;
based on preference information, extracting feature information from the acquired data;
generating the response to include at least one piece of information of the extracted feature information; and
outputting the generated response.

15. The method of claim 14, wherein determining whether to provide the response by retrieving the information comprises:
determining an intention of a user as to the voice input based on the result of analyzing the voice input; and
determining whether to provide the response by retrieving the information based on the determined intention of the user.

16. The method of claim 15, wherein determining whether to provide the response by retrieving the information based on the determined intention of the user comprises:
identifying a type of the response matched with the determined intention of the user based on information related to types of the response matched with intentions of the user; and
determining whether to provide the response by retrieving the information based on the identified type of the response.

17. The method of claim 14, wherein determining whether to provide the response by retrieving the information comprises:
determining a type of an action for providing the response based on the result of analyzing the voice input; and
determining whether to provide the response by retrieving the information based on the determined type of the action.

18. The method of claim 14, wherein determining whether to provide the response by retrieving the information comprises:
determining a feature of an element of the response based on the result of analyzing the voice input; and
determining whether to provide the response by retrieving the information based on the determined feature of the element.

19. The method of claim 14, wherein extracting the feature information from the acquired data comprises:
giving a weight to at least one piece of information included in the acquired data based on the preference information; and
extracting the feature information from the acquired data based on the given weight.

20. The method of claim 19, wherein generating the response comprises:
based on the extracted feature information comprising a plurality of pieces of information, setting priority of the plurality of pieces of information based on the weight given to each of the plurality of pieces of information;
determining an arrangement order of a plurality of elements corresponding to the plurality of pieces of information, respectively, based on the set priority; and
generating the response to include the plurality of elements based on the arrangement order of the plurality of elements.
